(19) United States
(12) Patent Application Publication
(10) Pub. No.: US 2006/0187356 A1
(43) Pub. Date: Aug. 24, 2006

(54) Video playback apparatus and video playback method

(76) Inventor: Yohzoh Ogura, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/349,802

(22) Filed: Feb. 8, 2006

(30) Foreign Application Priority Data
Feb. 24, 2005 (JP) 2005-048604

(51) Int. Cl. H04N 5/14; H04N 9/64; H04N 9/475; H04N 7/173

(52) U.S. Cl. 348/577; 725/100; 348/571; 348/513

(57) ABSTRACT

According to one embodiment, this invention is a video playback apparatus including a video storage unit which stores a compressed video signal, a decoding unit which decodes the video signal, an average color calculation unit which calculates an average color in a first frame included in the video signal, and an average color in a second frame to be detected upon a lapse of a predetermined time after the first frame, a difference calculation unit which calculates a difference between the average color in the first frame and the average color in the second frame, a determination unit which determines whether the difference calculated by the difference calculation unit is larger than a predetermined threshold value, and a playback control unit which controls to play back the video signal, in accordance with information on the second frame when the determination unit determines that the difference is larger than the threshold value.

### CROSS-REFERENCE TO RELATED APPLICATIONS

This application is based upon and claims the benefit of priority from prior Japanese Patent Application No. 2005-048604, filed Feb. 24, 2005, the entire contents of which are incorporated herein by reference.

### BACKGROUND

1. Field

One embodiment of the invention relates to a video playback apparatus and video playback method for detecting a point at which a video scene changes.

2. Description of the Related Art

In recent years, along with the improvements in information processing techniques, systems for digitalizing moving image and audio data, and recording and playing back the digital data have become very popular. The digital data can be copied without deterioration of information, and is suitable for an edit process. The digital data can also easily be played back from any point at which the user wants in a playback process.

In order to efficiently play back and edit the moving image and audio data, it is required to speedily search for and cue the recorded data.

It is disclosed by, for example, Jpn. Pat. Appln. KOKAI Publication No. 2002-77780 discloses a technique in which a change between scenes can be detected and stored by calculating a difference between the average luminance of all pixels in the block of a given frame and that in an immediately preceding frame to cue video data.

However, in a conventional apparatus, the frames having identical or similar luminances cannot be identified. That is, in the conventional apparatus, the change between the scenes having identical or similar luminances cannot be detected. As a result, although the scene actually changes, the change between the scenes may not be detected, and the user cannot efficiently cue the video data.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the main arrangement of a video playback apparatus according to an embodiment of the present invention;

FIG. 2 is a block diagram showing the main arrangement of a changing point detection unit according to the embodiment;

FIG. 3 is a view for explaining a target frame in a changing point detection process according to the embodiment;

FIG. 4 is a graph showing the example of change in average color of RGB image information according to the embodiment;

FIG. 5 is a flowchart showing the example of a process in the search operation of the changing point detection unit according to the embodiment;

FIG. 6 is a flowchart showing the example of the video search process of the video playback apparatus according to the embodiment; and

FIG. 7 is a flowchart showing the example of the set value change process of the changing point detection unit according to the embodiment.

### DETAILED DESCRIPTION

Various embodiments according to the invention will be described hereinafter with reference to the accompanying drawings. In general, according to one embodiment of the invention, this invention is a video playback apparatus comprising a video storage unit configured to store a compressed video signal, a decoding unit configured to perform a decoding process for the compressed video signal read out from the video storage unit, a display control unit configured to display, on a display unit, the video signal decoded by the decoding unit, an average color calculation unit configured to calculate an average color in a first frame included in the video signal decoded by the decoding unit, and an average color in a second frame to be detected upon a lapse of a predetermined time after the first frame, a difference calculation unit configured to calculate a difference between the average color in the first frame and the average color in the second frame which are calculated by the average color calculation unit, a determination unit configured to determine whether the difference calculated by the difference calculation unit is larger than a predetermined threshold value, and a playback control unit configured to control to play back the video signal stored in the video storage unit, in accordance with information on the second frame when the determination unit determines that the difference is larger than the threshold value.

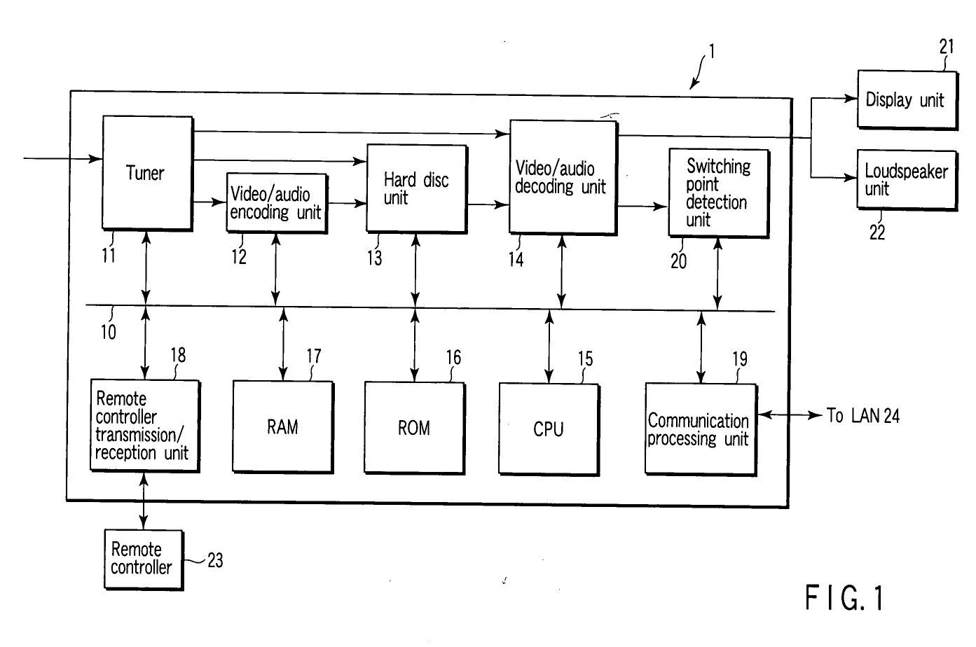

According to an embodiment, FIG. 1 shows a block diagram showing an example of the main arrangement of a video playback apparatus 1 according to the embodiment of the present invention.

The video playback apparatus 1 shown in FIG. 1 includes a tuner 11, video/audio encoding unit 12, hard disc unit (to be referred to as an HDD hereinafter) 13, video/audio decoding unit 14, CPU (Central Processing Unit) 15, ROM (Read Only Memory) 16, RAM (Random Access Memory) 17, remote controller transmission/reception unit 18, communication processing unit 19, changing point detection unit 20, and the like. The respective units are connected via a control bus 10.

The video playback apparatus 1 externally receives video and audio signals via the tuner 11, and supplies the received signals to the video/audio encoding unit 12, hard disc unit 13, or video/audio decoding unit 14 in accordance with the received signals or a user's instruction. The video/audio encoding unit 12 encodes the video and audio signals, and supplies the encoded signals to the HDD 13. The encoded video and audio signals are recorded in the HDD 13.

The video/audio decoding unit 14 decodes video and audio information which is read out from the HDD 13 or input from the tuner 11. The decoded video and audio signals are supplied to a display unit 21 such as a CRT, and a loudspeaker unit 22 which are subsequently connected to play back the video and audio signals. The video/audio decoding unit 14 also supplies the decoded video and audio signals to the changing point detection unit 20.

As will be described later, the changing point detection unit 20 calculates the average color in a target frame of the video information decoded by the video/audio decoding unit 14. The changing point detection unit 20 determines the frame in which the average color largely changes as a change between scenes, and stores information of the frame so that the change between the scenes can be used to search for and play back the subsequent video information. The video playback apparatus 1 can transmit/receive the video and audio signals recorded in the incorporated HDD 13 to/from the remaining recording/playback devices via the communication processing unit 19 and a LAN 24.

The CPU 15 controls the overall processing operations of the video playback apparatus 1. The ROM 16 stores a program and the like to be executed by the CPU 15. The RAM 17 serves as a storage unit used for the processing operation of the CPU 15. The remote controller transmission/reception unit 18 receives instruction information transmitted from a remote controller 23 operated by the user, and notifies the CPU 15 of the instruction information via the control bus 10.

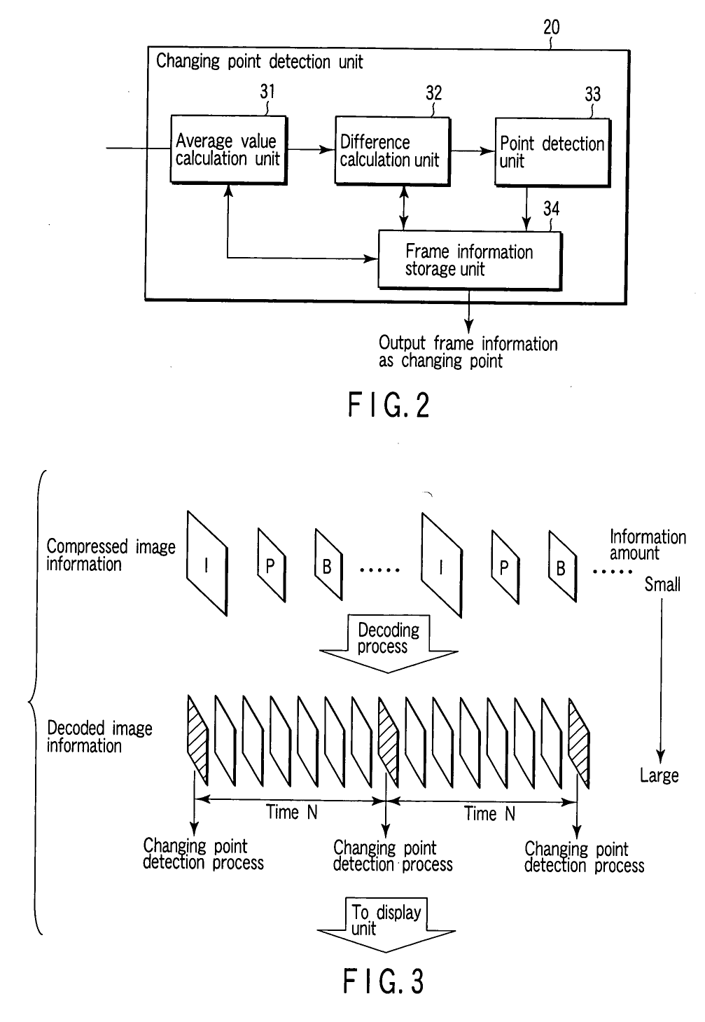

FIG. 2 is a block diagram showing the main arrangement of the changing point detection unit 20. The changing point detection unit 20 exemplified in FIG. 2 includes an average value calculation unit 31, difference calculation unit 32, point detection unit 33, and frame information storage unit 34.

The average value calculation unit 31 receives the decoded video signal from the video/audio decoding unit 14. This video signal is received in an RGB frame format. The average value calculation unit 31 calculates the average colors in the target frames at a predetermined time interval N, and the frame information storage unit 34 stores the average colors to supply average color information to the difference calculation unit 32. For example, the average color can be expressed as the value obtained by converting the value of RGB=8 bit, 8 bit, 8 bit into the value from 0 to FFh.

The difference calculation unit 32 reads out the average color information of the immediately preceding frame from the frame information storage unit 34, and calculates the difference between the readout average color information read out from the frame information storage unit 34 and that input from the average value calculation unit 31. The difference calculation unit 32 supplies the obtained difference information to the point detection unit 33, and the difference information is then stored in the frame information storage unit 34.

The point detection unit 33 compares the difference information from the difference calculation unit 32 with a predetermined threshold value M. As a result of comparison in the point detection unit 33, if a difference obtained based on this difference information is equal to or larger than the threshold value M, the frame information is stored in the frame information storage unit 34 as a changing point indicating the change between the scenes.

The frame information storage unit 34 stores the average color information of the target frame and the difference information. The frame information storage unit 34 also stores the frame information of the frame detected as the changing point at which a moving image scene is determined to have changed. This frame information is information for specifying the frame to specify and read out the video signal from the HDD 13 in which the video signals are stored. Note that a time interval N and the threshold value M set in the changing point detection unit 20 can be arbitrary changed by the user.

In this arrangement, as shown in FIG. 3, the video playback apparatus 1 according to the embodiment receives, from an external device or the HDD 13, compressed image information (YUV) containing a luminance signal (Y), chrominance signals (C), and the like. Reference symbols I, P, and B in FIG. 3 respectively denote Intra Picture, Predictive Picture, and Bidirectionally Picture. The video/audio decoding unit 14 decodes the compressed image information (YUV), and supplies, to the changing point detection unit 20, the image information serving as the video signal having a color tone (RGB) to be displayed on the display unit 21. The decoded image information includes the frames each consisting of 352 pixels×240 pixels at the rate of 30 frames per second. Each pixel includes 24 bits (RGB=8 bit, 8 bit, 8 bit).

On the basis of input RGB image information, the changing point detection unit 20 calculates the average colors in the target frames at a predetermined time interval N, and calculates the difference between the average color in the current target frame and that in the immediately preceding frame. The changing point detection unit 20 compares the difference with the predetermined threshold value M to detect the frame in which the scene has changed.

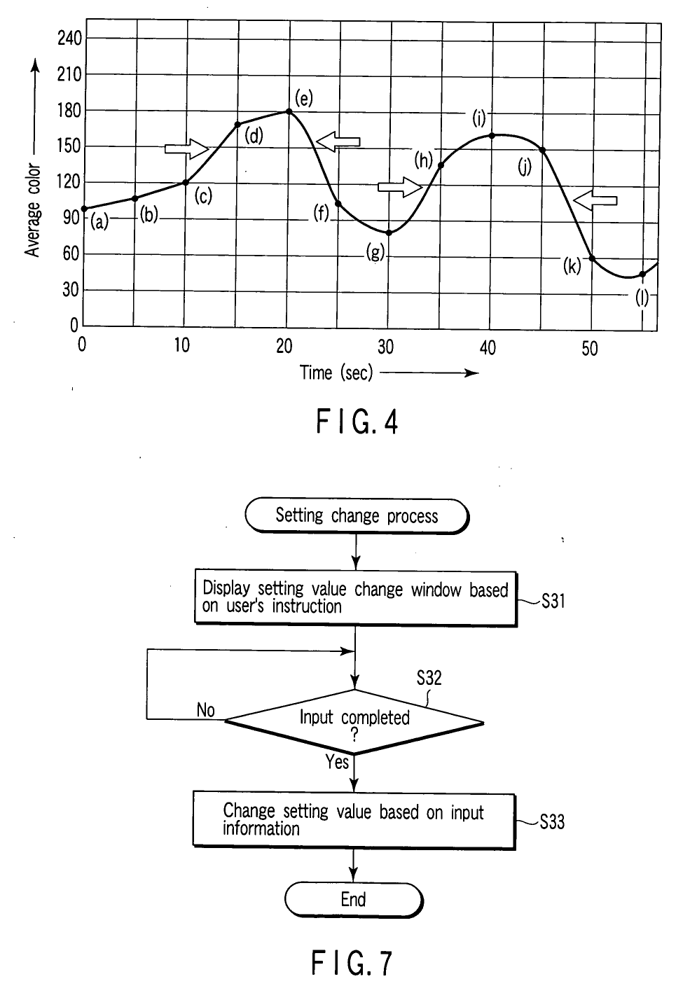

FIG. 4 is a view showing the change (shift) in the average color of the RGB image information. Assume that the time interval N for executing the changing point detection process is set to 5 sec, and the threshold value M of the difference is set to 30. In FIG. 4, reference symbols (a) to (1) respectively denote the frames each in which the changing point detection process has been executed.

In the RGB image information average color shown in FIG. 4, the difference becomes equal to or larger than the threshold value M in four intervals, i.e., the intervals between frames (c) and (d), frames (e) and (f), frames (g) and (h), and frames (i) and (k). Hence, the point detection unit 33 of the changing point detection unit 20 causes the frame information storage unit 34 to store the pieces of frame information in frames (d), (f), (h), and (k) as the scene changing points.

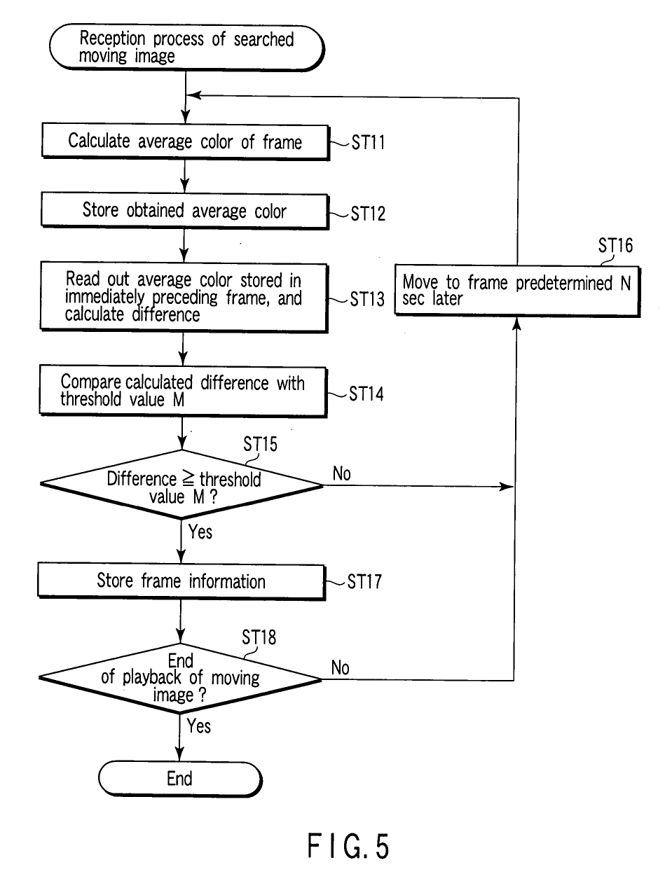

FIG. 5 is a flowchart showing the reception process of the moving image to be searched for in the changing point detection unit 20.

As shown in FIG. 5, upon reception of the decoded video signal from the video/audio decoding unit 14, the average value calculation unit 31 calculates the average colors in the target frames at the predetermined time interval N (step ST11). The average value calculation unit 31 then causes the frame information storage unit 34 to store the obtained average colors, and supplies the average color information to the difference calculation unit 32 (step ST12).

Upon reception of the average color information in step ST12, the difference calculation unit 32 reads out the average color information in the immediately preceding frame from the frame information storage unit 34. The difference calculation unit 32 then calculates the difference between the average color information input from the average value calculation unit 31 and that in the immediately preceding frame, and supplies the obtained difference information to the point detection unit 33 (step ST13). The point detection unit 33 compares the difference information from the difference calculation unit 32 with the predetermined threshold value M to determine whether the difference information is equal to or larger than the threshold value M (step ST14).

As a result of determination in step ST14, if it is determined that the difference information is not larger than the threshold value M (NO in step ST15), the process of the point detection unit 33 shifts to a succeeding frame to be detected upon the lapse of a predetermined N sec after the target frame, and the flow advances to step ST11 (step ST16). As a result of determination in step ST14, if it is determined that the difference information is equal to or larger than the threshold value M (YES in step ST15), the point detection unit 33 causes the frame information storage unit 34 to store the frame information (step S17).

In the changing point detection unit 20, if the target moving image data has not been completely played back (NO in step ST18), the process shifts to the succeeding frame to be detected upon the lapse of a predetermined N sec after the target frame (step ST16), and the flow then advances to step ST11.

Alternatively, if the target moving image data has been completely played back in step ST18 (YES in step ST18), a series of processes ends.

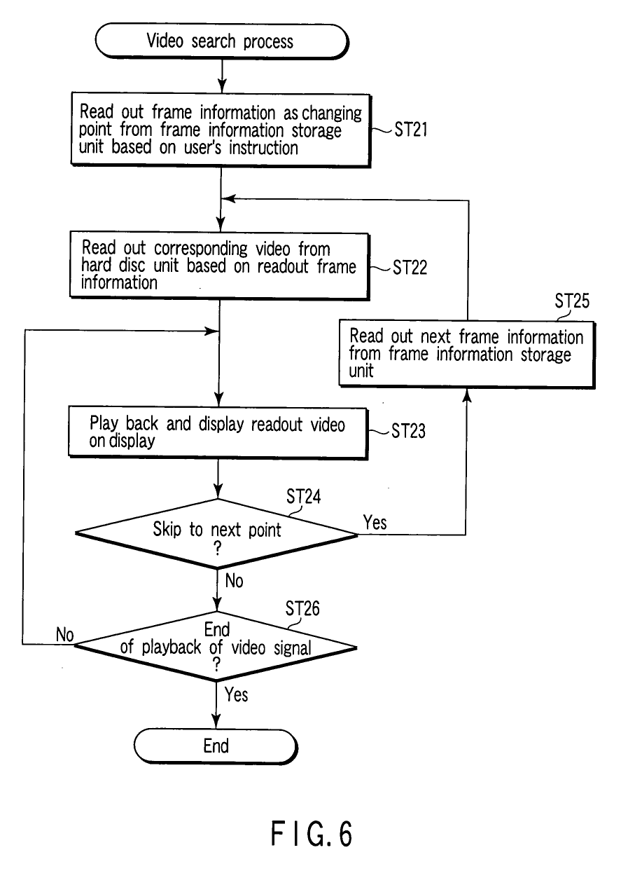

FIG. 6 is a flowchart showing a video search process in the video playback apparatus 1. As shown in FIG. 6, upon reception of the instruction from the user via the remote controller transmission/reception unit 18, the CPU 15 reads out, from the frame information storage unit 34, the frame information serving as the changing point (step ST21). The CPU 15 then reads out the corresponding video signal from the HDD 13 on the basis of the readout frame information (step ST22), and plays back and displays the readout video signal on the display unit (step ST23).

When the user instructs to skip to the next point via the remote controller transmission/reception unit 18 (YES in step ST24), the frame information of the next changing point is read out from the frame information storage unit 34 (step ST25). If the video signal has not been completely played back, and there is no instruction to skip to the next point (NO in steps ST24 and ST26), the flow advances to step ST23, and playback of the video signal is continued and displayed. When the video signal has been completely played back (YES in step ST26), the series of processes ends.

FIG. 7 is a flowchart showing the change process of a predetermined set value (time interval N and threshold value M) in the changing point detection unit 20. As shown in FIG. 7, upon reception of the instruction from the user via the remote controller transmission/reception unit 18, the CPU 15 displays a set value change window (not shown) on the display unit 21 (step ST31). In correspondence with the change window displayed in step ST31, upon reception of an input completion instruction from the user via the remote controller transmission/reception unit 18 (YES in step ST32), the CPU 15 changes the set value (time interval N and threshold value M) in the changing point detection unit 20 on the basis of the input information (step ST33).

As described above, the average colors in the target frames are calculated with respect to the RGB image information obtained after decoding the compressed video signal. The frame in which the average color largely changes is determined as the change between the scenes, and the determined frame information is stored. On the basis of the stored frame information, the video signal can be searched for and played back.

As described above, the change between the scenes can be determined by comparing the average colors in the frames of the decoded image information. Accordingly, the scene to be viewed or edited can be efficiently searched for, cued, and played back from the recorded video data.

A method of calculating the average color in the frame of the decoded image information can be easily implemented by a software process or a luminance average value calculation circuit incorporated in the display controller. Therefore, the method can be implemented using a general function without a dedicated circuit.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video playback apparatus comprising:
a video storage unit configured to store a compressed video signal;
a decoding unit configured to perform a decoding process for the compressed video signal read out from the video storage unit;
a display control unit configured to display, on a display unit, the video signal decoded by the decoding unit;
an average color calculation unit configured to calculate an average color in a first frame included in the video signal decoded by the decoding unit, and an average color in a second frame to be detected upon a lapse of a predetermined time after the first frame;
a difference calculation unit configured to calculate a difference between the average color in the first frame and the average color in the second frame which are calculated by the average color calculation unit;
a determination unit configured to determine whether the difference calculated by the difference calculation unit is larger than a predetermined threshold value; and
a playback control unit configured to control to play back the video signal stored in the video storage unit, in accordance with information on the second frame when the determination unit determines that the difference is larger than the threshold value.

2. An apparatus according to claim 1, further comprising a storage unit configured to store information on the first frame and the information on the second frame when the determination unit determines that the difference is larger than the threshold value.

3. An apparatus according to claim 1, further comprising a change unit configured to change the predetermined time in the average color calculation unit.

4. An apparatus according to claim 1, further comprising a change unit configured to change the threshold value in the difference calculation unit.

5. A video playback method of a video playback apparatus which includes a video storage unit configured to store a compressed video signal and a decoding unit configured to perform a decoding process for the compressed video signal read out from the video storage unit, and displays, on a display unit, the video signal decoded by the decoding unit, comprising:
a first calculation step of calculating an average color in a first frame included in the video signal decoded by the decoding unit;
a second calculation step of calculating an average color in a second frame to be detected upon a lapse of a predetermined time after the first frame included in the video signal decoded by the decoding unit;
a third calculation step of calculating a difference between the average color in the first frame and the average color in the second frame which are calculated in the first calculation step and the second calculation step;
a determination step of determining whether the difference calculated in the third calculation step is larger than a predetermined threshold value; and
a playback control step of controlling to play back the video signal stored in the video storage unit, in accordance with information on the second frame when the difference is determined to be larger than the threshold value in the determination step.

6. A method according to claim 5, further comprising a change step of changing the predetermined period of time in the second calculation step.

7. A method according to claim 5, further comprising a change step of changing the threshold value in the third calculation step.
